(19) United States
(12) Patent Application Publication
(10) Pub. No.: US 2016/0007616 A1
(43) Pub. Date: Jan. 14, 2016

(54) Looping Device for a Pretzel Shaping Machine

(71) Applicant: Attila Vranyoczky, Munich (DE)

(72) Inventor: Attila Vranyoczky, Munich (DE)

(21) Appl. No.: 14/794,915

(22) Filed: Jul. 9, 2015

(30) Foreign Application Priority Data
Jul. 9, 2014 (DE) 10 2014 109 929.0

(51) Int. Cl. A21C 3/08

(52) U.S. Cl. CPC A21C 3/08

(57) ABSTRACT

The invention relates to a looping device (10) for a pretzel shaping machine (12) with a base body (28), which has a resting area (26) for respective pretzel arms, and with a downholder (34) movable from an open position into a retaining position, by means of which the pretzel arms can be retained on the base body (28), wherein the looping device (10) includes a gripping device (42), by means of which the pretzel arms after moving the downholder (34) into the open position can be relocated and can be deposited on the pretzel arc of the pretzel. Furthermore, the invention relates to a pretzel shaping machine (12) with such a looping device (10) and a method for producing pretzels by means of such a looping device (10).

### FIELD OF THE INVENTION

The invention relates to a looping device for a pretzel shaping machine with a base body, which has a resting area for respective pretzel arms, and with a downholder movable from an open position into a retaining position, by means of which the pretzel arms can be retained on the base body. Furthermore, the invention relates to a pretzel shaping machine with such a looping device. Finally, the invention relates to a method for producing pretzels by means of a looping device, in which respective pretzel arms of a pretzel strand are deposited on a resting area of a base body and are retained on the base body by means of a downholder movable from an open position into a retaining position.

### BACKGROUND OF THE INVENTION

The production of pretzels is still associated with great manufacturing effort in the baker's craft. Usually, the shaping of the pretzels is manually effected even today, which results in high manufacturing cost and in a correspondingly expensive final product.

Therefore, since several years there are attempts to automate the manufacture of pretzels. An example of such an automatization is shown in DE 10 2007 039 631 B4. There, a pretzel shaping machine is provided, which includes a looping device with a base body rotatable around a looping axis as a central component. This base body has a resting area for respective pretzel arms. In addition, a downholder movable from an open position into a retaining position is provided, by means of which the pretzel arms are retained on the base body during the looping movement thereof around the looping axis. The looping movement of the base body around the looping axis—namely by 360 degrees—causes the generation of a node or a loop between the two pretzel arms, before the base body can subsequently be pivoted by 180 degrees around a tilting axis extending transversely to the looping axis. This subsequent pivoting by 180 degrees causes the two pretzel arms to be deposited on a pretzel arc of the pretzel. Thereby results the characteristic shape of the pretzel.

After the looping movement, thus, the entire looping device is pivoted around a tilting axis by about 180 degrees such that the pretzel arms are deposited on the pretzel. By further pressing the pretzel arms to the pretzel, finally, the finished pretzel is shaped. The pretzel shaping machine described in DE 10 2007 039 631 B4 has a particular process reliability and the manufacture proceeds without failures. Here, it is disadvantageous that the relocation of the pretzel arms is slow and laborious.

It is the object of the present invention to provide a looping device, a pretzel shaping machine as well as a method for producing pretzels, by means of which a particularly fast relocation of the pretzel arms is possible.

### BRIEF SUMMARY OF THE INVENTION

According to embodiments of the invention described herein, this object is solved by the objects of the independent patent claims. Advantageous embodiments with expedient developments of the invention are specified in the respectively dependent claims.

In order to provide a looping device, by means of which particularly fast relocation of the pretzel arms is possible, it is provided according to the invention that the looping device includes a gripping device, by means of which the pretzel arms after moving the downholder into the open position can be relocated and can be deposited on the pretzel arc of the pretzel.

The gripping device has the advantage that it is substantially smaller and has less mass than the entire looping device so that it can be faster moved than the complete looping device. In addition, a distance to be traveled by the gripping device for the relocation is smaller than a pivoting distance of the looping device pivotable for relocation. Correspondingly, particularly fast relocation of the pretzel arms is possible. Furthermore, the mechanics, in particular the bearings, of the gripping device is exposed to substantially lower loads than a bearing, which has to support the entire looping device. Correspondingly, the looping device can be configured less expensively and particularly compact. In addition, the use of a less powerful motor for moving the gripping device is possible than it is possible with a looping device, which is pivoted completely.

In further advantageous configuration of the invention, it is provided that the base body is rotatable around a looping axis, the pretzel arms are retained on the base body by means of the downholder during the looping movement thereof around the looping axis and the pretzel arms can be relocated and can be deposited on the pretzel arc of the pretzel by means of the gripping device after the end of the looping movement of the base body and moving the downholder into the open position. Thereby, the pretzel arms are particularly securely retained on the base body by the downholder during the looping movement so that a pretzel machine with such a looping device operates with particular process reliability.

Furthermore, it is advantageous if the gripping device is rotatable around a looping axis and the pretzel arms can be relocated and can be deposited on the pretzel arc of the pretzel by means of the gripping device after the end of its looping movement. The looping axis of the gripping device is preferably vertical. In order to allow the looping movement, the downholder is moved into the open position already before the looping movement by the gripping device. In that the gripping device performs the looping movement, the pretzel can be particularly fast shaped.

Therein, it is particularly advantageous if the gripping device includes a respective gripper for the associated pretzel arm. In other words, this means that the gripping device includes two grippers, thus each one gripper per pretzel arm. In contrast to a gripping device with only one gripper, thereby, both pretzel arms can thus be relocated at the same time, by which the relocation of the pretzel arms is particularly fast. Furthermore, movement kinematics of a gripping device with two grippers is substantially simpler to configure than it is possible with only one gripper. With only one provided gripper, it has to be movable at least around an additional axis to be able to relocate both pretzel arms. Thereby, the gripping device is therefore also particularly inexpensive.

It has additionally proven advantageous if the gripping device includes respective pressing elements, by means of which the pretzel arms can be pressed to the pretzel arc of the pretzel. These pressing elements can for example be movable stamping blocks or the like, which are arranged within the gripper of the gripping device and press the pretzel arms down to the pretzel arc after relocation. Herein, the pressing elements can preferably be moved relative to the grippers by means of corresponding actuators. Thereby, the shaping of the pretzel can overall be accelerated since an additional working step can be omitted. Optionally, an additional device for pressing the pretzel arms to the pretzel arc can thus be omitted such that the pretzel shaping machine is particularly inexpensive. The pressing of the pretzel arms to the pretzel arc thus occurs substantially at the same time with the relocation. In addition, the production method has thus a particular process reliability since it is always ensured that the pretzel arms are also hit by the pressing elements. Furthermore, the pressing by means of the pressing elements can particularly well prevent slipping of the pretzel arms in further transport. Thus, the pressing element then adopts the function of a positioning element.

In further configuration of the invention, it has additionally proven advantageous if the respective grippers of the gripping device are rotatable around their respective center axis. Thereby, an orientation of the pretzel arms relative to the node of the pretzel generated by the looping movement of the looping device can be changed during depositing on the pretzel arc of the pretzel. Thereby, it is possible to produce a pretzel, which is particularly well shaped. In particular, thus, a pretzel can be produced, the shape of which is particularly similar to that of a manually shaped pretzel. Thereby, the perceived quality of the finished pretzel is particularly high.

An advantageous development of the invention additionally provides that the base body includes axially adjustable studs, which are adjustable between a retaining position, in which the respective pretzel arm can be detachably retained on the base body together with the downholder, and a refracted position, whereby the respective pretzel arm can be gripped by the associated gripper. Thereby, it is first possible that the gripper of the gripping device is able to grip the respective pretzel arms when the studs are in the retracted position without the downholder having to be moved into the open position. Therein, respective prongs of respective gripping elements of the grippers correspond to respective gaps between respective prongs of the downholder. Therefore, the gripper can enter this gap with its gripping elements and grip the respective pretzel arms without the downholder having to be moved into the open position. Thus, the pretzel arms are retained by the downholder until they are securely received by the gripping device. The prongs of the gripping elements are for example cut out from a sheet part constituting the gripping elements for example by laser. In order to avoid an adhering of the pretzel arms to the gripping elements, they can be coated with a non-stick coating such as TEFLON.

When the downholder is then subsequently shifted into the open position, the pretzel arms are already retained by the gripping device. Thus, overall, the pretzel arms are retained during the entire shaping process such that the pretzel production is possible with particular process reliability by means of the looping device according to the invention. Furthermore, the pretzel arms are also retained in a defined position during gripping of the gripping device such that this operation is also possible with particular process reliability. Namely, based on experience, the fact is that especially failures, which are attributable to a fault during the relocating operation, in particular false gripping of the pretzel arms, result in high disruption times and in corresponding personnel expenditure to remove the residues of the pretzel or of a dough strand.

In further advantageous configuration of the invention, a respective further hold-down element is provided, by means of which the pretzel arc can be held down in the transitional area to the respective pretzel arm. During the relocation of the pretzel arms, bulging of the pretzel in this area can occur, then, the pretzel has a shape bent upwards. Furthermore, the pretzel arc can deform in undesired manner by the relocation. By the respective further hold-down elements, the pretzel arc is held down in the transitional area in such a way that as a flat pretzel arises and the pretzel arc does not deform in undesired manner. The finished shape of the pretzel is then particularly high-quality. Such a bulging of the pretzel or undesired deformation of the pretzel arc in particular occurs if a particularly fast relocation of the pretzel arms takes place. By means of the further hold-down elements, it is thus possible to relocate the pretzel arms particular fast since even by a higher speed in relocating, the undesired bulging of the pretzel and/or the undesired deformation of the pretzel arc is prevented by the further hold-down element.

The features and advantages described above in connection with the looping device apply in similar manner to the pretzel shaping machine with an embodiment of the looping device described above.

In further configuration of the pretzel shaping machine, it has proven advantageous if a rotary table with a plurality of processing stations is provided, at least one of which is constituted by the looping device. The rotary table has the advantage that processing stations can be installed in fixed positions and at the same time transport of the pretzel or of a pretzel blank from one processing station to the next is particularly simple. In particular, the pretzel blank can remain in a pretzel mold and be transported therein from one processing station to the next. Thereby, the pretzel shaping machine has a particular process reliability since the pretzel itself only has to be moved relative to the pretzel mold for the looping and the relocating movement. In addition, a particularly high clock cycle in the manufacture of the pretzel is possible by means of the rotary table.

The pretzel shaping machine is particularly advantageously configured if a stamping device with two stamps is provided, which includes a shifting element for shifting back one of the pretzel arms into an original position after slipping. During a transport, a pretzel arm can slip, in particular the pretzel arm facing away from a transport direction. Due to the transport, one of the two pretzel arms can for example even slip out of the pretzel mold. This slipping is undone by the shifting element. If the shifting element is a part of the stamping device, shifting back can be effected immediately before pressing the pretzel arms to the pretzel arc. Thereafter, the slipping is substantially rarer due to the pressed-on pretzel arms so that the pretzels can be produced with a particular process reliability. Therein, the shifting element can be configured as an immovable element such as for example as a plastic or sheet part. The shifting back is then effected by a transport movement of the pretzel blanks and thereby pressing the slipped pretzel arm against the shifting element. Thereby, the shifting element can be particularly inexpensively configured.

The features and advantages described above in connection with the looping device and the pretzel shaping machine similarly apply to the method for producing pretzels.

### BRIEF DESCRIPTION OF DRAWINGS

The foregoing and further advantages, features and details of the invention are apparent from the following description of preferred embodiments as well as illustrated in the accompanying drawings. The accompanying drawings, which are incorporated herein and form a part of the specification, further serve to explain the principles of the invention and to enable a person skilled in the pertinent art to make and use the invention.

FIG. 1 is a perspective view of a pretzel shaping machine according to a first embodiment, with a looping device, wherein it has a base body rotatable around a looping axis, which has a resting area for respective pretzel arms, and with a downholder movable from an open position into a retaining position, by means of which the pretzel arms are retained on the base body during the looping movement thereof around the looping axis, wherein the looping device includes a gripping device, by means of which the pretzel arms after moving the downholder into the open position can be relocated and can be deposited on a pretzel arc of the pretzel after the end of the looping movement of the base body.

FIG. 2 is a perspective view of the pretzel shaping machine according to FIG. 1, wherein respective grippers of the gripping device are shown in a gripping position.

FIG. 3 is a pretzel shaping machine according to FIG. 1, wherein the grippers of the gripping device are shown in a position for depositing the pretzel arms on the pretzel arc.

FIG. 4 is a perspective view of the pretzel shaping machine according to a second embodiment, wherein a rotary table with a plurality of processing stations is provided, at least one of which is constituted by the looping device according to FIG. 1.

FIG. 5 is a perspective view of the pretzel shaping machine according to a third embodiment with a straight front of the downholder.

FIG. 6 is a perspective view of the looping device according to the embodiment of the pretzel shaping machine according to FIG. 5.

### DETAILED DESCRIPTION OF THE INVENTION

Specific embodiments of the present invention are now described with reference to the figures. The following detailed description is merely exemplary in nature and is not intended to limit the invention or the application and uses of the invention.

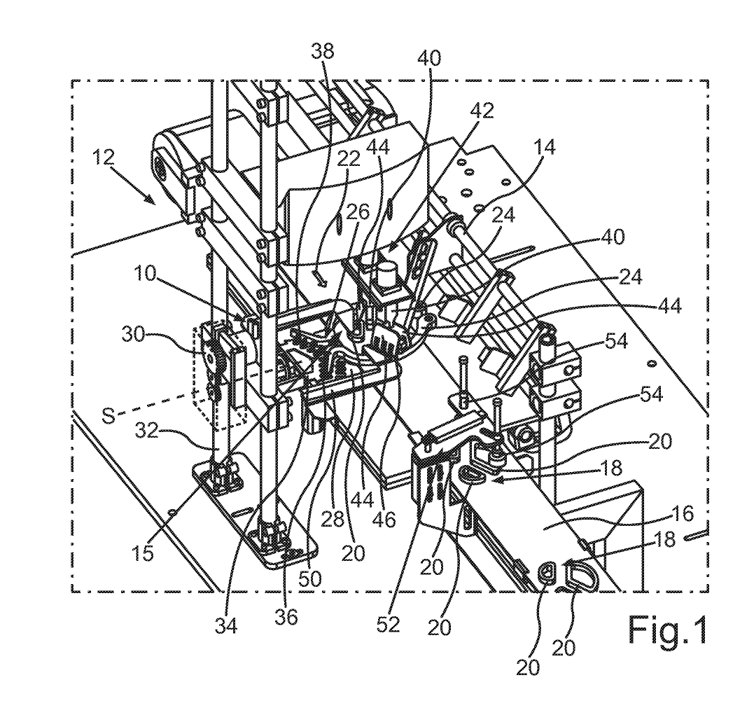

FIG. 1 shows a looping device 10 for a pretzel shaping machine 12 in a perspective view. For producing a pretzel, first, a pretzel blank is conveyed to a conveyor belt 16 by means of a conveyor device, of which only the retaining linkage 14 is shown here. On this conveyor belt 16, the pretzel blank, which is shaped substantially as an elongated, straight dough part at this time, gets into abutment on a pretzel mold 18. Therein, the pretzel mold 18 includes three mold elements 20, in which the pretzel is shaped in further manufacturing steps. Thereto, the conveyor belt 16 conveys the pretzel mold 18 with the abutting pretzel blank towards the looping device 10. This conveying movement is also illustrated by the arrow 22.

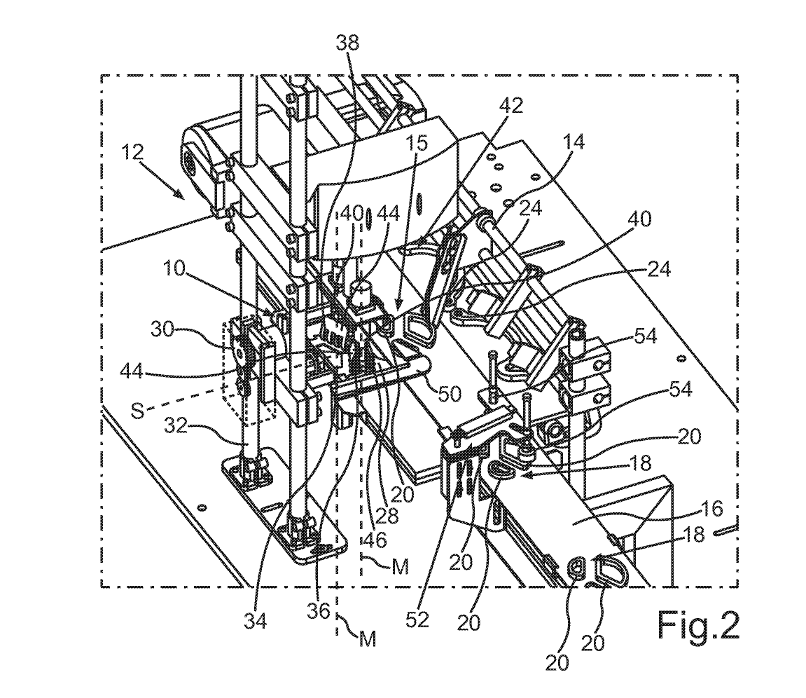

When the pretzel blank has arrived at the level of the looping device 10, by adjusting two mold arms 24 disposed next to the conveyor belt 16 into an end position, as it is seen in FIG. 1, the pretzel blank is pressed into an omega shape around the pretzel mold 18. Therein, a previous open position of the mold arms 24 is also seen in the perspective view of the pretzel shaping machine 12 according to FIG. 2. Therein, the mold arms 24 press the pretzel blank into such a position that the respective pretzel arms rest on a resting area 26 of a base body 28 rotatable around a looping axis S. Therein, the base body 28 is supported on a linkage 32 via a transmission 30 and rotatable by 360 degrees by means of a drive.

After the mold arms 24, as shown in FIG. 2, have again been shifted into an open position, in which they do no longer have contact with the pretzel blank and also cannot block the rotary movement or looping movement of the base body 28, a downholder 34 is moved from an open position into a retaining position. In the retaining position of the movable downholder 34, the pretzel arms are retained on the base body 28 during the looping movement thereof around the looping axis S. Thereby, the pretzel arms are prevented from being able to detach from the base body 28 during the looping movement of 360° around the looping axis S. Therein, the downholder 34 is disposed opposing the mold arms 24 next to the conveyor belt 16 and configured as a type of triangular element, which has respective prongs 36 spaced from each other on its front side facing the pretzel blank and the conveyor belt 16. The open position of the downholder 34 is for example shown in FIG. 2, the retaining position in FIG. 1.

Furthermore, the base body 28 includes axially adjustable studs 38, which are adjustable between a retaining position, in which the respective pretzel arm can be detachably retained on the base body 28 together with the downholder 34, and a retracted position. These studs 38 first cause a still better and more exact positioning of the pretzel arms during the looping movement and also prevent the pretzel arms from being able to detach from the base body 28 during the looping movement such that the production process is particularly little error-prone.

After the end of the looping movement, in which a node has been produced in the pretzel blank on the pretzel arms by means of the rotary movement of the base body 28 around the looping axis S by 360 degrees, which later constitutes the typical shape of a finished pretzel, the studs 38 are adjusted into the retracted position. Thereby, the respective pretzel arms can be gripped by a respectively corresponding gripper 40 of a gripping device 42. At the same time, however, the pretzel arms are still further retained on the base body 28 in a defined position by the downholder 34 in retaining position. Thus, gripping of the pretzel arms with a particular process reliability by the gripping device 42 is possible.

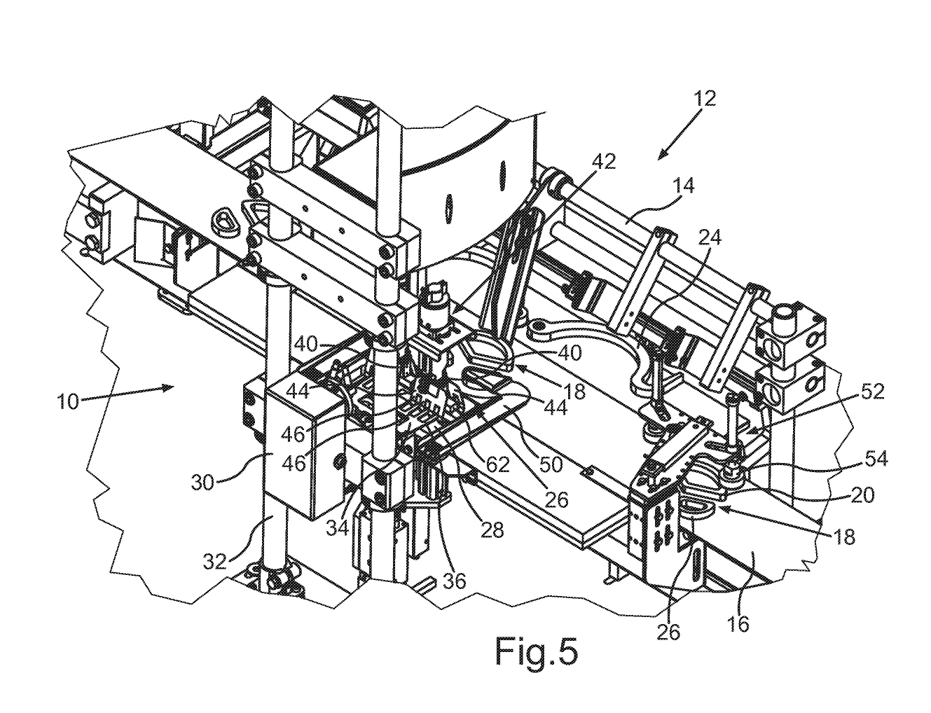

The grippers 40 have two flat gripping elements 44 of formed sheet, by means of which the pretzel arms can be embraced or encompassed. Therein, the gripping elements 44 include respective prongs 46, which correspond to gaps between the prongs 36 of the downholder 34. Thereby, the pretzel arms can be gripped by the gripping device 42 when the downholder 34 is in the retaining position. Thereby, possible slipping of the pretzel arms or other failure sources are particularly effectively reduced such that the production process has a particular process reliability. This is particularly well apparent in the perspective view of the pretzel machine 10 in FIG. 5. Such a gripping position of the gripping device 42 is also seen in FIG. 2. In this embodiment of the pretzel machine 10, the front of the downholder 34 is configured straightly and not as a triangular element as in the embodiment of the pretzel shaping machine 10 according to FIGS. 1 to 4. Thereby, the gaps between the prongs 46 of the downholder 34 can be configured particularly small since the gaps are straight to an entering direction of the prongs 46 of the gripping elements 44. Correspondingly, in this embodiment, the mold arms 24 are also configured slightly differently to further allow complete abutment of the pretzel arms on the downholder 34.

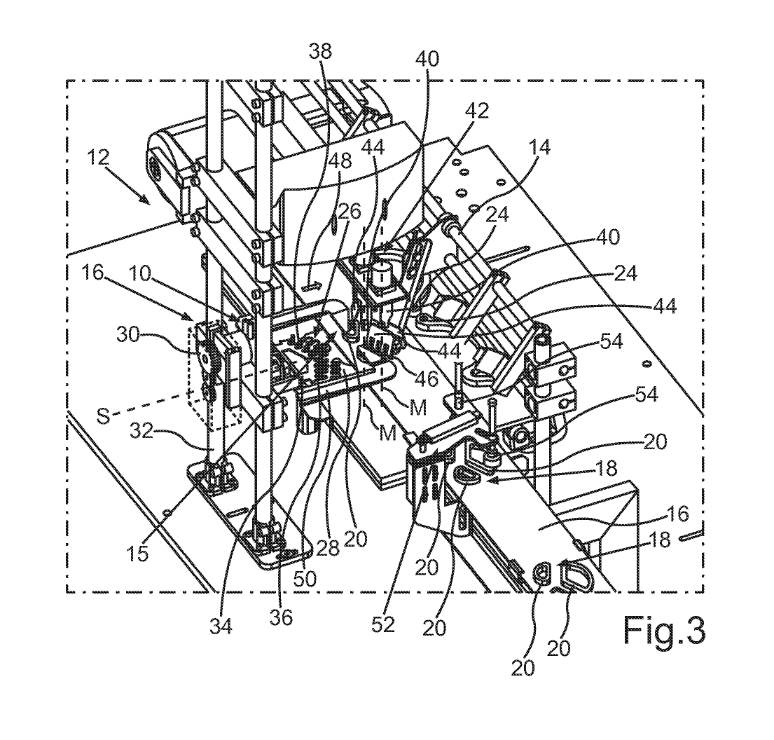

After the grippers 40 have gripped the pretzel arms, they are deposited on a pretzel arc of the pretzel blank by a relocating movement after the downholder element 34 has been moved into its open position. Thereto, the grippers 40 are first moved upwards such that they lift the pretzel arms and lift them off from the base body 28, subsequently, the grippers 40 are moved towards the conveyor belt 16 or the pretzel mold 18, which is illustrated by the arrow 48 in FIG. 3. Subsequently, the pretzel arms are then deposited on the pretzel arc of the pretzel in an end position of the grippers 40. Thereby, the pretzel arms and the pretzel node then are in gaps between the mold elements 20 of the pretzel mold 18 so that the typical pretzel shape has been created.

In this movement illustrated by the arrow 48, the grippers 40 also simultaneously rotate around their respective center axis M. In that the grippers 40 are rotatable around their center axis M, the grippers 40 can particularly well grip the pretzel arms in the omega shape of the pretzel blank as it is shown in FIG. 2. Subsequently, the gripper 40 can create a more natural pretzel shape more similar to a manually shaped pretzel shape by means of the rotation around the center axis M. A position of the grippers 40 with respect to a rotation and their end position for depositing the pretzel arms on the pretzel arc are shown in FIG. 3.

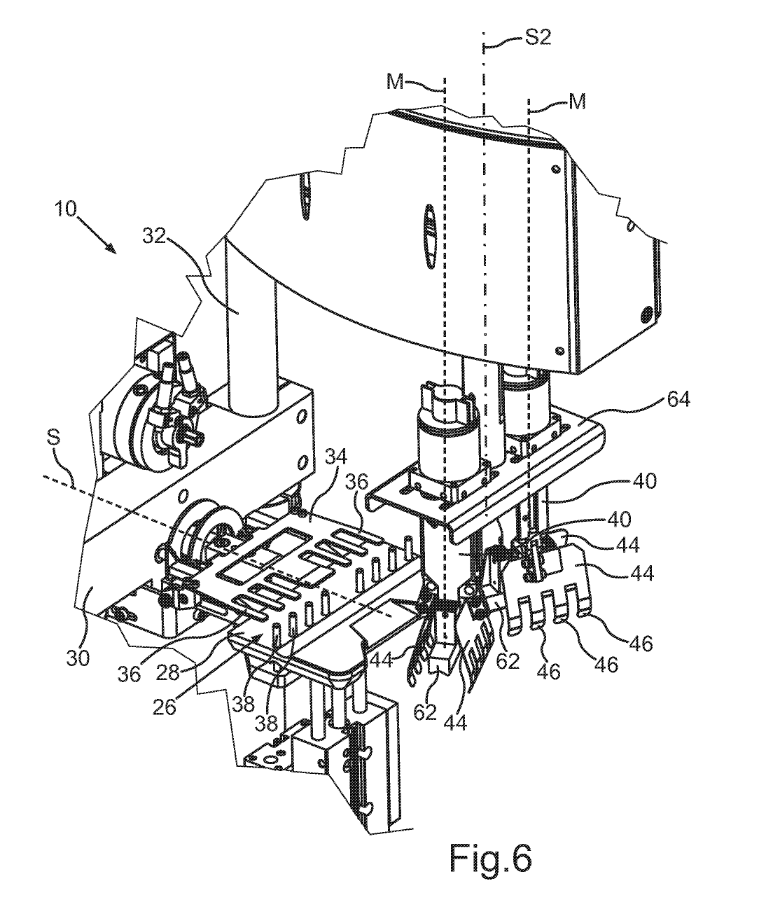

In an alternative embodiment of the looping device 10, the base body 28 is not rotatable, but immovably supported. Thereto, the gripping device 42 is rotatable around a vertical looping axis S2 substantially perpendicular to the base body 28 by 360°, which is shown in FIG. 6. Alternatively, the grippers 40 can for example also be supported on a base body 64 of the gripping device 42, which is rotatable around the looping axis S2 perpendicular to the base body 28 by 360°. The pretzel arms are directly gripped by the respectively corresponding gripper 40, after the pretzel blank has been pressed into the omega shape and while the pretzel arms are retained on the base body 28 by the downholder 34 in retaining position. Subsequently, the downholder 34 is moved into the open position and the pretzel arms are lifted off from the base body 28 by the grippers 40. Thereafter, the looping movement of 360° around the looping axis S2 perpendicular to the base body is effected to also produce the node typical to a pretzel in the pretzel blank on the pretzel arms. Thereafter, the pretzel arms are relocated by means of the gripping device 42 and deposited on the pretzel arc of the pretzel as already described.

After the deposition thereof, the pretzel arms are at least slightly pressed to the pretzel arc by means of respective pressing elements 62 of the grippers 40. Therein, the pressing elements 62 are particularly well apparent in the perspective view of the looping device 10 in FIG. 6. The pressing elements 62 are for example formed as blocks with non-stick coating and can be axially moved by means of respective lifting cylinders. On their lower side facing the pretzel arms, the blocks of the pressing elements 62 for example include milled notches to once again reduce possible adhering of the pretzel arms to the pressing elements 62. Therein, the pressing of the pretzel arms to the pretzel arc occurs substantially at the same time with the relocation. The production method thus has a particular process reliability since it is always ensured that the pretzel arms are also encountered by the pressing elements 62. Furthermore, the pressing by means of the pressing elements 62 can particularly well prevent slipping of the pretzel arms in a further transport.

Furthermore, a further hold-down element 50 is provided on the looping device 10. This further hold-down element 50 is substantially composed of two L-shaped components, which are adjustable in a vertical direction to the conveyor belt. Before the gripping device 42 relocates the pretzel arms on the pretzel arc of the pretzel, these further hold-down elements 50 are lowered so far that they retain a part of the pretzel blank on the conveyor belt and/or the base body 28. Thereby, the pretzel blank is prevented from bending upwards with respect to the conveyor belt and the base body during relocating or occurrence of undesired deformation of the pretzel arc is prevented. The hold-down element 50 therefore causes a flat pretzel with the known typical pretzel shape being able to be produced. In particular, it allows a particularly fast movement of the grippers 40 and thereby particularly fast relocation of the pretzel arms. Thereby, increased clock cycle in the production of pretzels by means of the looping device 10 is possible.

After the typical pretzel shape has now been generated by means of the looping and the subsequent relocating movement, the conveyor belt 16 moves the pretzel mold 18 with the pretzel blank located therein to a stamping device 52. This stamping device 52 includes two stamps 54, which press the pretzel arms to the pretzel arc by means of a substantially cylindrical head. This is in particular required if pressing elements 62 are not provided in the grippers 40. In addition, the gripping device 42 can be configured such that they only slightly fix the pretzel arms. Thereby, there is enough time for a soft pretzel dough to cause possibly present dents by the grippers 40 and/or the pressing elements 62 to again vanish for example by settling and fermenting processes by the transport up to the stamping device 52. Especially due to pressing, irregularities can otherwise be introduced into the pretzel, which can otherwise result in increased reject rate. If the finished pressing of the pretzel arms is already affected by the pressing elements 62, otherwise increased clock cycle can be realized in pretzel manufacture. Subsequently, the finished shaped pretzels are further transported by means of the conveyor belt 16, in particular to a furnace.

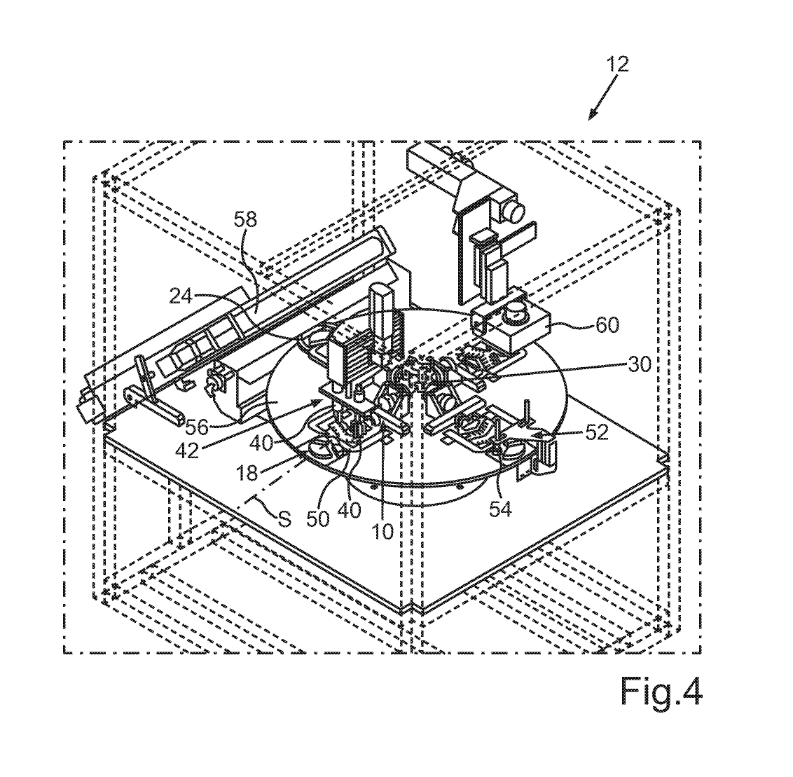

FIG. 4 shows in a perspective view an alternative embodiment of the pretzel shaping machine 12. It includes a rotary table 56 with a plurality of processing stations, at least one of which is constituted by the looping device 10. Therein, the method for producing pretzels by means of this looping device 10 substantially remains the same. By means of a conveyor device 58, pretzel blanks are transported onto the rotary table 56 and brought into an omega shape by means of respective mold arms 24. Therein, the pretzel blank abuts on a pretzel mold 18 and is rotated to a gripping device 42 via rotation of the table. Already during this rotation, the looping movement of the base body 28 around the looping axis S can occur, wherein the pretzel blank is retained on the base body 28 or the resting area 26 by the downholder 34. Subsequently, the relocation of the pretzel arms is effected by means of the grippers 40 of the gripping device 42 on the pretzel arc of the pretzel. Thereafter, the table further rotates to a stamping device 52, which presses the pretzel arms to the pretzel arc by means of respective pressing elements. After a further rotary movement of the table, the now completely shaped pretzel arrives at a vacuum box 60, which sucks the pretzel from the rotary table 56 and can transport it to further processing stations.

Thus, the embodiment of the pretzel shaping machine 12 with rotary table 56, as it is shown in FIG. 4, once again allows faster production of pretzels since the looping movement can be effected simultaneously with the transport of the pretzel blank to the gripping device 42. Otherwise, the production here has an equal process reliability since the pretzel blank is retained by the downholder 34 or the grippers 40 substantially all the time during the looping and relocating movement.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

### LIST OF REFERENCE CHARACTERS

10 Looping device
12 Pretzel shaping machine
14 Retaining linkage
16 Conveyor belt
18 Pretzel mold
20 Mold element
22 Arrow
24 Mold arms
26 Resting area
28 Base body
30 Transmission
32 Linkage
34 Downholder
36 Prongs
38 Studs
40 Gripper
42 Gripping device
44 Gripping elements
46 Prongs
48 Arrow
50 Hold-down element
52 Stamping device
54 Stamp
56 Rotary table
58 Conveyor device
60 Vacuum box
62 Pressing element
64 Base body
S Looping axis
S2 Looping axis
M Center axis

1. A looping device for a pretzel shaping machine comprising:
a base body, which has a resting area for respective pretzel arms, and with a downholder movable from an open position into a retaining position, by means of which the pretzel arms can be retained on the base body, wherein the looping device further includes a gripping device, by means of which the pretzel arms after moving the downholder into the open position can be relocated and can be deposited on a pretzel arc of a pretzel.

2. The looping device according to claim 1, wherein the base body is rotatable around a looping axis, the pretzel arms are retained on the base body by means of the downholder during the looping movement thereof around the looping axis and the pretzel arms can be relocated and can be deposited on the pretzel arc of the pretzel by means of the gripping device after the end of the looping movement of the base body and moving the downholder into the open position.

3. The looping device according to claim 1, wherein the gripping device is rotatable around a looping axis and the pretzel arms can be relocated and can be deposited on the pretzel arc of the pretzel by means of the gripping device after the end of its looping movement.

4. The looping device according to claim 1, wherein the gripping device includes a respective gripper for the associated pretzel arm.

5. The looping device according to claim 1, wherein the gripping device includes respective pressing elements, by means of which the pretzel arms can be pressed to the pretzel arc of the pretzel.

6. The looping device according to claim 1, wherein the respective grippers of the gripping device are rotatable around their respective center axis.

7. The looping device according to claim 1, wherein the base body includes axially adjustable studs, which are adjustable between a retaining position, in which the respective pretzel arm can be detachably retained on the base body together with the downholder, and a retracted position, whereby the respective pretzel arm can be gripped by the associated gripper.

8. The looping device according to claim 1, wherein a respective further hold-down element is provided, by means of which the pretzel arc can be held down in a transitional area to the respective pretzel arm.

9. A pretzel shaping machine for producing pretzels, the pretzel shaping machine having a looping device according to claim 1.

10. The pretzel shaping machine according to claim 9, further comprising:
a rotary table with a plurality of processing stations, wherein at least one of the plurality of processing stations is constituted by the looping device.

11. The pretzel shaping machine according to claim 9, further comprising:
a stamping device with two stamps, which includes a shifting element for shifting back one of the pretzel arms into an original position after slipping.

12. A method for producing pretzels by means of a looping device, in which respective pretzel arms of a pretzel strand are deposited on a resting area of a base body and are retained on the base body by means of a downholder movable from an open position into a retaining position, wherein
after moving the downholder into the open position the pretzel arms are relocated and deposited on a pretzel arc of a pretzel by means of a gripping device.
